(19) United States
(12) Patent Application Publication
(10) Pub. No.: US 2024/0149109 A1
(43) Pub. Date: May 9, 2024

(54) KNEE JOINT REHABILITATION APPARATUS FOR WHEELCHAIR

(71) Applicant: HEXARHUMANCARE CO., LTD, Ansan-si, Gyeonggi-do (KR)

(72) Inventors: Chang Soo HAN, Seoul (KR); Ho Jun KIM, Seoul (KR); Su Hyu PARK, Hwaseong-si (KR); Young Hoon JI, Ansan-si (KR); Jeong Ho CHO, Hanam-si (KR); Byung Gab RYU, Ansan-si (KR); Jeong Gyu PARK, Incheon (KR); Dong Eun CHOI, Ansan-si (KR); Cheol Woong AHN, Seoul (KR)

(73) Assignee: HEXARHUMANCARE CO., LTD, Ansan-si, Gyeonggi-do (KR)

(21) Appl. No.: 18/282,384

(22) PCT Filed: Jan. 10, 2022
(86) PCT No.: PCT/KR2022/000350

§ 371 Date: Sep. 15, 2023

(30) Foreign Application Priority Data
Mar. 17, 2021 (KR) 10-2021-0034475
Nov. 18, 2021 (KR) 10-2021-0159352

(51) Int. Cl. A63B 23/04; A61G 5/10; A61G 5/12

(52) U.S. Cl. CPC A63B 23/04; A61G 5/101; A61G 5/127

(57) ABSTRACT

A knee joint rehabilitation apparatus for a wheelchair includes a rehabilitation apparatus frame having a height corresponding to a length of each of legs of a patient sitting on the wheelchair; an upper leg support disposed at an upper end of the rehabilitation apparatus frame and supporting upper legs of the patient thereon while the patient is sitting on the wheelchair; a lower leg support pivotably connected to the upper leg support, wherein the lower legs of the patient are seated and supported on the lower leg support; and an exercise control unit disposed on the rehabilitation apparatus frame and configured to allow the lower leg support to pivot around a connection portion between the lower leg support and the upper leg support such that the patient performs rehabilitation exercise of the knee joint thereof while sitting on the wheelchair.

### BACKGROUND OF THE DISCLOSURE

### 1. Field of the Disclosure

The present disclosure relates to a knee joint rehabilitation apparatus for the wheelchair. More specifically, the present disclosure relates to a knee joint rehabilitation apparatus for a wheelchair that allows a patient to smoothly perform rehabilitation exercises of a knee joint while sitting on the wheelchair without getting off the wheelchair.

### 2. Description of the Related Art

Generally, after knee joint surgery, rehabilitation treatment on the knee joint begins through rehabilitation exercises. A purpose of the rehabilitation is to strengthen a muscle strength and restore a joint motion range.

For example, a patient with degenerative arthritis often has weakened knee muscles due to pain before the surgery. After the surgery, the knee muscles are further weakened due to pain and swelling.

After the knee joint surgery, rehabilitation treatment not only reduces pain while strengthening the knee muscles compared to before the surgery, but also allows the movement and strength of the knee joint to be recovered more quickly. Furthermore, as blood circulation in the leg is promoted through the rehabilitation treatment, blood clots as one of the major aftereffects may be prevented.

The knee joint rehabilitation treatment is classified into exercise treatment and non-exercise physical therapy. The exercise treatments include a joint motion range improvement training that increases the joint motion range, a muscle strength training using a knee joint exercise device such as an elastic rubber band or sling, a walking training, and a balance training.

Typically, during the rehabilitation exercise of the knee joint, the patient moves to the exercise treatment room while getting on the wheelchair, then and gets on one of the rehabilitation exercise devices in the exercise treatment room, and performs rehabilitation exercise using the selected rehabilitation exercise device. At this time, when the rehabilitation exercise using the rehabilitation exercise device is completed, the patient moves back to the wheelchair, and moves to another rehabilitation exercise device, and repeatedly performs rehabilitation exercise using the another rehabilitation exercise device. Then, when the rehabilitation exercise of the knee joint is finally completed, the patient is transferred to the wheelchair, and leaves the exercise treatment room, and moves to the hospital room.

As described above, the rehabilitation exercise of the knee joint requires the patient with poor knee joints to repeatedly get on and off the wheelchair. In the process, problems with the knee joint may occur due to the patient's mistakes or external shocks.

Therefore, in recent years, various methods and rehabilitation devices have been researched and developed to allow the patient to smoothly perform the rehabilitation exercise of the knee joint without adversely affecting the patient's knee joint. In particular, various rehabilitation devices are being researched and developed that may allow the patient to perform the rehabilitation exercises of the knee joint while sitting on a wheelchair.

Related prior art documents include Korean Patent No. 10-1793812 (Title of the invention: Rehabilitation exercise apparatus for knee joint, registration date: Oct. 30, 2017), and Korean Patent No. 10-2024636 (Title of the invention: Knee joint rehabilitation apparatus, registration date: 2019.09.18).

### SUMMARY OF THE DISCLOSURE

An embodiment of the present disclosure provides a knee joint rehabilitation apparatus for a wheelchair that allows the patient to stably and smoothly perform rehabilitation exercises of the knee joint while sitting on the wheelchair without getting off the wheelchair.

Furthermore, an embodiment of the present disclosure provides a knee joint rehabilitation apparatus for a wheelchair that can prevent the wheelchair from moving abnormally and leaving its original position when the patient is performing rehabilitation exercises of the knee joint while sitting on the wheelchair.

One aspect of the present disclosure provides a knee joint rehabilitation apparatus for a wheelchair, the apparatus comprising: a rehabilitation apparatus frame having a height corresponding to a length of each of legs of a patient sitting on the wheelchair; an upper leg support disposed at an upper end of the rehabilitation apparatus frame and supporting upper legs of the patient thereon while the patient is sitting on the wheelchair; a lower leg support pivotably connected to the upper leg support, wherein the lower legs of the patient are seated and supported on the lower leg support; and an exercise control unit disposed on the rehabilitation apparatus frame and configured to allow the lower leg support to pivot around a connection portion between the lower leg support and the upper leg support such that the patient performs rehabilitation exercise of the knee joint thereof while sitting on the wheelchair.

In one implementation, the apparatus further comprises a wheelchair fixing unit disposed on each of both opposing sides of a lower end of the rehabilitation apparatus frame and configured to fix the wheel of the wheelchair to prevent unintentional movement of the wheelchair when the wheelchair has been moved to a set position for the rehabilitation exercise of the knee joint.

In one implementation, the wheel of the wheelchair includes a main wheel provided on each of both opposing sides of the wheelchair; and an auxiliary wheel provided on each of both opposing sides of a front portion of the wheelchair to assist the movement of the main wheel, wherein when the wheelchair has been positioned at the set position, the auxiliary wheel is stopped and fixed by the wheelchair fixing unit.

In one implementation, the wheelchair fixing unit includes: a wheel support plate formed in a shape of a plate and mounted on the lower end of the frame body so that the wheel of the wheelchair gets on the wheel support plate as the wheelchair is moving to the set position; and a wheel fixing portion formed on a top of the wheel support plate so as to fix the wheel of the wheelchair having got on the top of the wheel support plate.

In one implementation, the wheel fixing portion includes a wheel receiving groove defined in an upper portion of the wheel support plate and extending along a direction in which the wheel of the wheelchair moves so that a lower portion of the wheel of the wheelchair having got on the wheel support plate is inserted into the wheel receiving groove.

In one implementation, the wheel fixing portion further includes a wheel stopper disposed on a bottom surface defining the wheel receiving groove and having a structure constructed to stop the lower portion of the wheel of the wheelchair to fix the wheel of the wheelchair inserted into the wheel receiving groove, wherein the wheel stopper is embodied as a stopping protrusion protruding from the bottom surface defining the wheel receiving groove at a wheel inlet position thereof, or a stopping hole formed in a center of the bottom surface defining the wheel receiving groove.

In one implementation, the wheelchair fixing unit is installed on each of both opposing sides of a lower end of the rehabilitation apparatus frame, wherein the wheelchair fixing unit is able to be displaced in an anteroposterior direction to adjust positions of the lower leg support and the upper leg support in the anteroposterior direction in a corresponding manner to positions in the anteroposterior direction of the legs of the patient sitting on the wheelchair.

In one implementation, a height of the rehabilitation apparatus frame is adjusted so as to adjust vertical levels of the lower leg support and the upper leg support in a corresponding manner to vertical levels of the legs of the patient sitting on the wheelchair.

In one implementation, the rehabilitation apparatus frame includes a frame body fixedly mounted on a ground; a mount frame on which the lower leg support, the upper leg support, and the exercise control unit are installed; and a vertical level adjustment unit connected to and disposed between the mount frame and the frame body and configured to adjust a vertical level of the mount frame.

The knee joint rehabilitation apparatus for the wheelchair according to an embodiment of the present disclosure may allow the patient to stably and smoothly perform the rehabilitation exercise of the knee joint while sitting on the wheelchair without getting off the wheelchair.

Furthermore, in accordance with the knee joint rehabilitation apparatus for the wheelchair according to the embodiment of the present disclosure, when the wheelchair has been displaced at a position suitable for rehabilitation exercise of the knee joint, the wheels of the wheelchair are fixed by the wheelchair fixing unit disposed on the rehabilitation apparatus frame. Thus, the wheelchair may be prevented from unintentionally moving out of the set position due to external force or impact generated during the rehabilitation exercise of the knee joint, and accordingly, the rehabilitation exercise of the knee joint may be performed stably while the wheelchair is placed at the set position.

Furthermore, according to the knee joint rehabilitation apparatus for the wheelchair according to the embodiment of the present disclosure, the wheel receiving groove of the wheel fixing portion is formed in the wheel support plate of the wheelchair fixing unit. Thus, when the wheelchair has been displaced to the set position for rehabilitation exercise of the knee joint, the wheels of the wheelchair may be inserted into the wheel receiving grooves. The wheel of the wheelchair is inserted into the wheel receiving groove and is stopped by the wheel stopper to stably fix the position of the wheelchair during the rehabilitation exercise of the knee joint.

Furthermore, according to the knee joint rehabilitation apparatus for the wheelchair according to the embodiment of the present disclosure, the vertical levels of the lower leg support and the upper leg support may be easily adjusted using the vertical level adjustment unit of the rehabilitation apparatus frame. The installation location of the wheel fixing portion installed on each of both opposing sides of the lower end of the rehabilitation apparatus frame may be changed in the anteroposterior direction. Thus, the positions of the lower leg support and the upper leg support may be easily adjusted in the anteroposterior direction. Therefore, the positions and the vertical levels of the lower leg support and the upper leg support may be appropriately adjusted according to the positions and the vertical levels of the legs of the patient sitting on the wheelchair to appropriately comply with various patient body types and various types of wheelchairs.

### BRIEF DESCRIPTION OF THE DRAWINGS

The above and other purposes, features and other advantages of the present disclosure will be more clearly understood from the following detailed description taken in conjunction with the accompanying drawings, in which:

FIG. 1 is a diagram schematically showing a knee joint rehabilitation apparatus for a wheelchair according to an embodiment of the present disclosure;

FIG. 2 is a diagram showing a state in which a wheelchair is placed at a set position of the knee joint rehabilitation apparatus for the wheelchair shown in FIG. 1;

FIG. 3 is a diagram showing a wheelchair fixing unit of the knee joint rehabilitation apparatus for a wheelchair as shown in FIG. 1;

FIG. 4 is a diagram schematically showing a knee joint rehabilitation apparatus for a wheelchair according to another embodiment of the present disclosure; and

FIG. 5 and FIG. 6 are diagrams showing a wheelchair fixing unit of the knee joint rehabilitation apparatus for a wheelchair as shown in FIG. 4.

### DETAILED DESCRIPTION OF THE DISCLOSURE

Specific structural and functional descriptions of embodiments according to the concept of the present disclosure disclosed herein are merely illustrative for the purpose of explaining the embodiments according to the concept of the present disclosure. Furthermore, the embodiments according to the concept of the present disclosure can be implemented in various forms and the present disclosure is not limited to the embodiments described herein.

The embodiments according to the concept of the present disclosure may be implemented in various forms as various modifications may be made. The embodiments will be described in detail herein with reference to the drawings. However, it should be understood that the present disclosure is not limited to the embodiments according to the concept of the present disclosure, but includes changes, equivalents, or alternatives falling within the spirit and scope of the present disclosure.

The terms such as “first” and “second” are used herein merely to describe a variety of constituent elements, but the constituent elements are not limited by the terms. The terms are used only for the purpose of distinguishing one constituent element from another constituent element. For example, a first element may be termed a second element and a second element may be termed a first element without departing from the scope of rights according to the concept of the present invention.

It will be understood that when an element is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Other words used to describe the relationship between elements should be interpreted in a like fashion (e.g., “between,” versus “directly between,” “adjacent,” versus “directly adjacent,” etc.).

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” in the specification should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

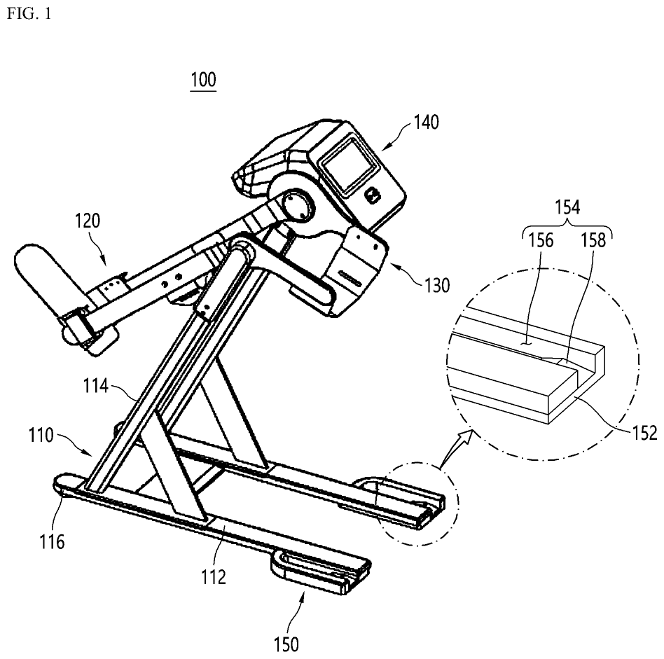

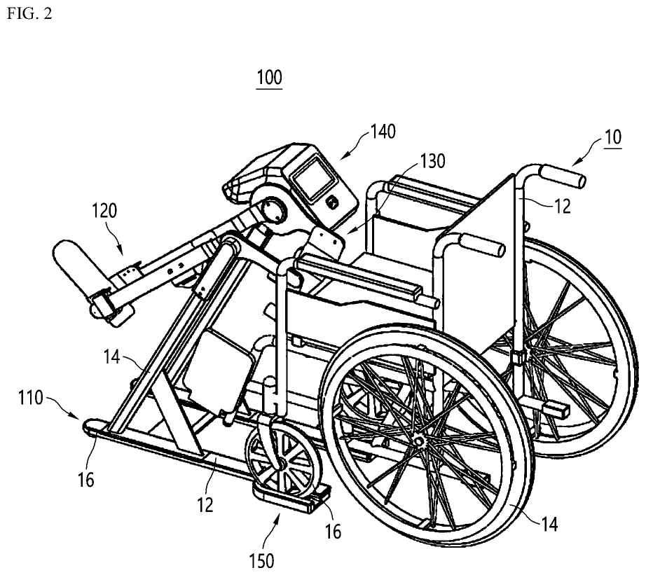

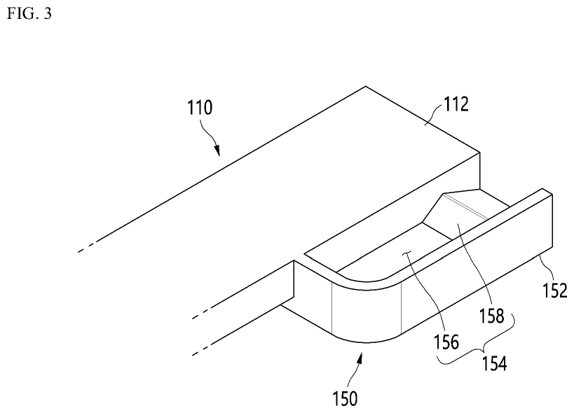

FIG. 1 is a diagram schematically showing a knee joint rehabilitation apparatus 100 for a wheelchair according to an embodiment of the present disclosure. FIG. 2 is a diagram showing a state in which the wheelchair 10 is placed at a set position of the knee joint rehabilitation apparatus 100 for the wheelchair as shown in FIG. 1. FIG. 3 is a diagram showing a wheelchair fixing unit 150 of the knee joint rehabilitation apparatus 100 for the wheelchair as shown in FIG. 1.

Referring to FIG. 1 and FIG. 2, a knee joint rehabilitation apparatus 100 for a wheelchair according to an embodiment of the present disclosure includes a rehabilitation apparatus frame 110, an upper leg support 130, a lower leg support 120, an exercise control unit 140, and a wheelchair fixing unit 150.

Typically, a patient who needs the rehabilitation exercise on the knee joint has difficulty in standing or walking alone, and thus may reach the knee joint rehabilitation apparatus 100 using a wheelchair 10. The knee joint rehabilitation apparatus 100 for a wheelchair of this embodiment may be configured to allow the patient to stably perform the rehabilitation exercise of the knee joint while the patient is sitting on the wheelchair 10.

The knee joint rehabilitation apparatus 100 for a wheelchair may be placed and fixed to a ground in a place where rehabilitation exercise of the knee joint is to be performed. Accordingly, the patient may reach the knee joint rehabilitation apparatus 100 for the wheelchair while sitting on the wheelchair 10 and stop at a set position suitable for the rehabilitation exercise of the knee joint.

For reference, the wheelchair 10 may include a wheelchair main body 12 and wheels 14 and 16. In this regard, the wheelchair main body 12 may be formed in a form of a chair on which the patient may sit. In addition, the wheels 14 and 16 of the wheelchair may include main wheels 14 respectively provided on both opposing sides of the main body 12 of the wheelchair 10, and auxiliary wheels 16 respectively provided on both opposing sides of a front portion of the main body of the wheelchair 10 to assist in the movement of the main wheels 14.

Referring to FIG. 1 and FIG. 2, the rehabilitation apparatus frame 110 of this embodiment may have a height corresponding to a length of each of the legs of the patient sitting on the wheelchair 10. As a result, each of a lower leg support 120 and an upper leg support 130 installed on the rehabilitation apparatus frame 110 may be positioned at a vertical level corresponding to each of lower and upper legs of the patient sitting on the wheelchair 10. The rehabilitation apparatus frame 110 as described above may be made of each of various materials depending on a design condition and a circumstance of the knee joint rehabilitation apparatus 100 for the wheelchair. Hereinafter, an example in which the frame structure is made of metal with excellent strength will be described.

For example, the rehabilitation apparatus frame 110 may include a frame body 112 that is seated and fixed on the ground, a mount frame 114 on which the lower leg support 120, the upper leg support 130, and the exercise control unit 140 are installed, and a frame pad 116 disposed on a lower surface of the frame body 112.

In this regard, the frame body 112 refers to a structure for supporting a load and vibration of the knee joint rehabilitation apparatus 100 for the wheelchair.

In addition, a low end of the mount frame 114 may be connected to the frame body 112, while the lower leg support 120, the upper leg support 130, and the exercise control unit 140 may be installed at an upper end of the mount frame 114. Therefore, it is preferable that the mount frame 114 is formed to have a length corresponding to a sum of heights of the lower leg support 120 and the upper leg support 130.

Furthermore, the frame pad 116 may be formed to have a predetermined thickness and may be mounted on the lower surface of the frame body 112. Hereinafter, in this embodiment, an example in which the frame pad 116 is disposed only on a front portion of the lower surface of the frame body 112, and the frame pad 116 is not installed on a rear portion of the lower surface of the frame body 112, and the wheelchair fixing unit 150 disposed at the rear portion of the lower surface of the frame body 112 acts as the frame pad 116 will be described.

Referring to FIG. 1 and FIG. 2, the upper leg support 130 of this embodiment may support an upper leg while the patient is sitting on the wheelchair 10 during rehabilitation exercise of the knee joint. The upper leg support 130 may be fixed to an upper end of the mount frame 114 of the rehabilitation apparatus frame 110.

Referring to FIG. 1 and FIG. 2, the lower leg support 120 of this embodiment may support a lower leg while the patient is sitting on the wheelchair 10 during rehabilitation exercise of the knee joint. The lower leg support 120 and the upper leg support 130 as described above may support the lower leg and the upper leg of the patient in need of rehabilitation exercise, respectively. The lower leg support 120 is pivotably connected to the upper leg support 130, and may be forcibly and repeatedly pivoted under a driving force of the exercise control unit 140. Therefore, the patient's lower leg together with the lower leg support 120 may be repeatedly pivotable around the knee joint. Thus, the rehabilitation of the knee joint may be achieved.

Referring to FIG. 1 and FIG. 2, the exercise control unit 140 of this embodiment may provide the driving force to the lower leg support 120 such that the lower leg support 120 may pivot around a connection portion of the lower leg support 120 and the upper leg support 130. The exercise control unit 140 as described above may be disposed on the upper end of the mount frame 114 of the rehabilitation apparatus frame 110, and has a drive shaft connected to the connection portion of the lower leg support 120 and the upper leg support 130 to provide the driving force to the lower leg support 120. Therefore, the exercise control unit 140 may move the patient's knee joint while sitting on the wheelchair 10, thereby allowing the patient to perform the rehabilitation exercise.

The exercise control unit 140 may include a manipulation unit for controlling or setting an operation of the knee joint rehabilitation apparatus 100 for the wheelchair, a display unit for displaying an operating status of the knee joint rehabilitation apparatus 100 for the wheelchair, an analyzer for measuring and analyzing the rehabilitation exercise using the knee joint rehabilitation apparatus 100 for a wheelchair, and a motor that provides the driving force to the drive shaft connected to the connection portion between the lower leg support 120 and the upper leg support 130.

Referring to FIG. 1 and FIG. 2, the wheelchair fixing unit 150 of this embodiment may fix the wheels 14 and 16 of the wheelchair 10 when the wheelchair 10 has been moved to a set position appropriate for the rehabilitation exercise of the knee joint, thereby preventing unintentional movement of the wheelchair 10. The wheelchair fixing unit 150 may be provided on each of both opposing sides of a lower end of the rehabilitation apparatus frame 110. Hereinafter, in this embodiment, an example in which each of the auxiliary wheels 16 of the wheels 14 and 16 of the wheelchair 10 is fixed to each wheelchair fixing unit 150 is described. However, the present disclosure is not limited thereto, and the wheelchair fixing unit 150 may be configured so that the main wheel 14 is fixed to the wheelchair fixing unit 150.

That is, when the patient has been moved to the set position while sitting on the wheelchair 10, the auxiliary wheel 16 of the wheelchair 10 may be placed on a top of the wheelchair fixing unit 150 and then may be caught in the wheelchair fixing unit 150. In this regard, a stopping force by which the wheelchair fixing unit 150 stops the auxiliary wheel 16 increases in proportion to loads of the wheelchair 10 and the patient. Thus, the wheelchair fixing unit 150 can stably fix the position of the wheelchair 10 at the set position, thereby preventing an abnormal movement of the wheelchair 10 due to vibration or shock generated during the rehabilitation exercise of the knee joint.

For example, the wheelchair fixing unit 150 may include a wheel support plate 152 and a wheel fixing portion 154.

The wheel support plate 152 may be a plate-shaped member mounted on each of both opposing sides of a lower portion of the frame body 112. As the wheelchair 10 has been moved to the set position, the auxiliary wheel 16 of the wheelchair 10 may get on a top of the wheel support plate 152. For example, the wheel support plate 152 may include a first support plate disposed at a lower portion of the frame body 112, and a second support plate connected to the first support plate and placed next to the frame body 112 so that the auxiliary wheel 16 of the wheelchair 10 may get on the second support plate.

In this regard, the first support plate may be disposed in close contact with the lower portion of the frame body 112, and may be formed to have a thickness equal to that of the frame pad 116 so as to play the role of the frame pad 116 while being disposed at the rear position of the lower portion of the frame body 112. The first support plate as described above may be fastened and fixed to the lower portion of the frame body 112 with a fastening member or adhesive.

In addition, the second support plate is formed in a shape that protrudes laterally from a side surface of the lower portion of the frame body 112 so that the auxiliary wheel 16 gets on the second support plate when the wheelchair 10 is moving to the set position. The second support plate may be formed to have the same thickness as that of the lower portion of the frame body 112. The wheel fixing portion 154 may be disposed on a top of the second support plate as described above.

The wheel fixing portion 154 has a structure for fixing the auxiliary wheel 16 of the wheelchair 10 getting on the top of the second support plate, and may be formed integrally with an upper portion of the second support plate of the wheel support plate 152. In one example, the wheel fixing portion 154 includes a wheel receiving groove 156 into which a lower portion of the auxiliary wheel 16 of the wheelchair 10 getting on the second support plate of the wheel support plate 152 is fixedly inserted, and a wheel stopper 158 for fixing the auxiliary wheel 16 inserted into the receiving groove 156 in the inside of the wheel receiving groove 156.

In this regard, the wheel receiving groove 156 may be defined in a groove shape in an upper portion of the second support plate of the wheel support plate 152 and extend along a moving direction of the auxiliary wheel 16. In this embodiment, the wheel receiving groove 156 may extend in an elongate manner in a direction in which the wheelchair 10 approaches the rehabilitation apparatus frame 110, wherein a width of the wheel receiving groove 156 is slightly larger than that of the auxiliary wheel 16. Therefore, the wheel receiving groove 156 may play a role in guiding the movement of the auxiliary wheel 16 when the wheelchair 10 is moving. In addition, when the wheelchair 10 has been positioned at the set position, the wheel receiving groove 156 may play a role in preventing the auxiliary wheel 16 from moving in a side direction.

Additionally, the wheel stopper 158 may be provided on a bottom surface defining the wheel receiving groove 156 and may have a structure that stops the auxiliary wheel 16 of the wheelchair 10. For example, the wheel stopper 158 may be provided as a stopping protrusion on the bottom surface defining the wheel receiving groove 156 at a wheel inlet position thereof. An inclined surface may be formed on the above-mentioned stopping protrusion so that the auxiliary wheel 16 may smoothly pass over the inclined surface when the wheelchair 10 is moving.

An operation and effects of the knee joint rehabilitation apparatus 100 for the wheelchair according to an embodiment of the present disclosure structured as described above are as follows.

First, the patient who needs rehabilitation exercise of the knee joint moves to the knee joint rehabilitation apparatus 100 for the wheelchair while sitting on the wheelchair 10.

The patient moves the wheelchair 10 toward the rehabilitation apparatus frame 110 of the knee joint rehabilitation apparatus 100 for the wheelchair and places the wheelchair 10 at the set position suitable for rehabilitation exercise of the knee joint.

When the wheelchair 10 has been placed at the set position as above, the auxiliary wheel 16 of the wheelchair 10 gets on the top of the wheel support plate 152 of the wheelchair fixing unit 150 and is fixed by the wheel fixing portion 154.

Specifically, the auxiliary wheel 16 of the wheelchair 10 is inserted into the wheel receiving groove 156 of the wheel fixing portion 154 while being getting on the top of the wheel support plate 152. In the process in which the wheel 16 is inserted into the wheel receiving groove 156, the wheel 16 is caught by the wheel stopper 158 and is stably fixed inside the wheel receiving groove 156.

As described above, when the wheelchair 10 is stably fixed at the set position by the wheelchair fixing unit 150, the patient may place the upper and lower legs that are required to be subjected to the rehabilitation exercise on the upper and lower leg supports 130 and 120, respectively while sitting on the wheelchair 10. Then, the patient operates the exercise control unit 140 such that the lower leg support 120 repeatedly pivots around the connection portion between the lower leg support 120 and the upper leg support 130.

Therefore, the patient's knee joint is repeatedly folded and unfolded under the pivoting exercise of the lower leg support 120, thereby repeatedly performing the rehabilitation exercise.

When the rehabilitation exercise of the knee joint has been completed, the operation of the exercise control unit 140 is stopped and the patient's upper and lower legs are removed from the upper leg support 130 and the lower leg support 120, respectively.

Then, the patient moves the wheelchair 10 backwards while slightly lifting a front portion of the wheelchair 10 around the main wheel 14. Thus, a load acting on the auxiliary wheel 16 is greatly reduced. Thus, the auxiliary wheel 16 can easily pass over the wheel stopper 158 and can be easily removed from the wheel stopper 158.

The patient moves the wheelchair 10 backwards and thus moves the auxiliary wheel 16 to a location away from the wheelchair fixing unit 150, and then move the wheelchair 10 to a position far enough away from the knee joint rehabilitation apparatus 100 for the wheelchair 10.

As described above, the patient comfortably performs the rehabilitation exercise of the knee joint using the knee joint rehabilitation apparatus 100 for the wheelchair while sitting on the wheelchair 10. When the knee joint rehabilitation exercise has been completed, the patient may easily and simply remove the wheelchair 10 from the knee joint rehabilitation apparatus 100 for the wheelchair while sitting on the wheelchair 10.

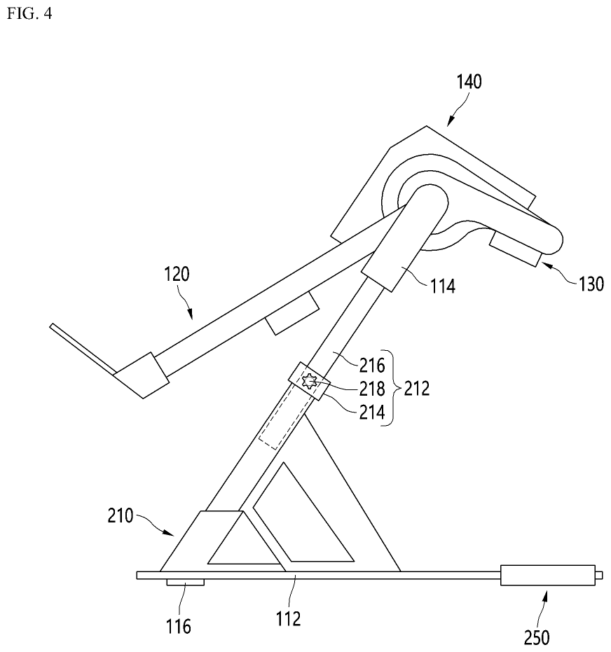

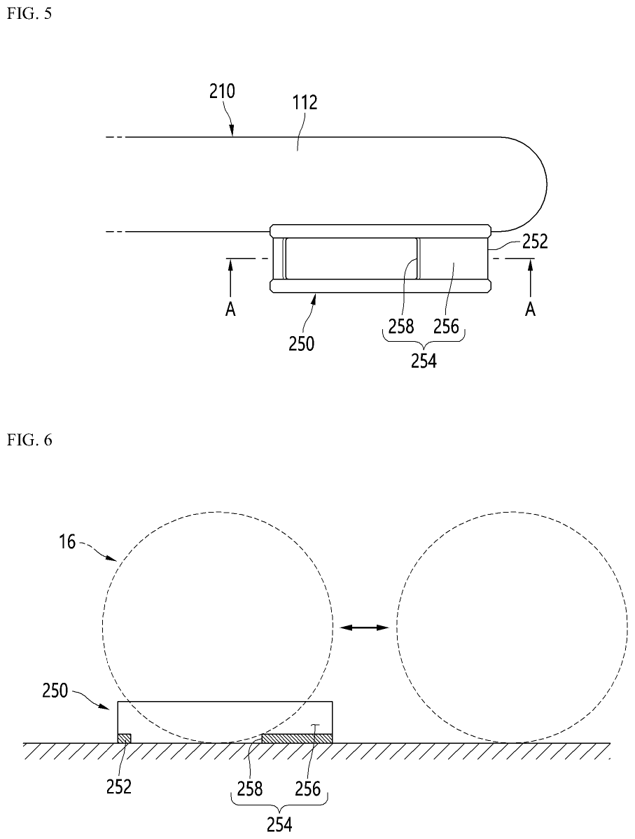

FIG. 4 is a diagram schematically showing a knee joint rehabilitation apparatus 200 for a wheelchair according to another embodiment of the present disclosure. FIG. 5 and FIG. 6 are diagrams showing a wheelchair fixing unit 250 of the knee joint rehabilitation apparatus 200 for the wheelchair as shown in FIG. 4.

In FIGS. 4 to 6, similar reference numerals that are the same as those shown in FIGS. 1 to 3 indicate the same members as those shown in FIGS. 1 to 3, and detailed descriptions thereof will be omitted. Hereinafter, the description will focus on differences from the knee joint rehabilitation apparatus 100 for the wheelchair as shown in FIGS. 1 to 3.

Referring to FIGS. 4 to 6, a knee joint rehabilitation apparatus 200 for a wheelchair according to another embodiment of the present disclosure is different from the knee joint rehabilitation apparatus 100 for a wheelchair shown in FIGS. 1 to 3 in terms of a structure of each of a rehabilitation apparatus frame 210 and a wheelchair fixing unit 250. In this regard, the rehabilitation apparatus frame 210 of this embodiment has a structure in which positions of the lower leg support 120 and the upper leg support 130 may be adjusted in a vertical direction with respect to the legs of the patient sitting on the wheelchair 10.

As shown in FIG. 4, the rehabilitation apparatus frame 210 may include the frame body 112 that is seated and fixed on the ground, the mount frame 114 on which the lower leg support 120, the upper leg support 130, and the exercise control unit 140 are mounted, the frame pad 116 disposed on the lower surface of the frame body 112, and a vertical level adjustment unit 212 connected to and disposed between the mount frame 114 and the frame body 112 and configured to adjust a vertical level of the mount frame 114.

Since the frame body 112 and the frame pad 116 are formed in the same structure as those of the frame body 112 and frame pad 116 as shown in FIGS. 1 and 2, detailed descriptions thereof will be omitted.

The mount frame 114 has the same structure as the mount frame 114 as shown in FIGS. 1 and 2. the vertical level adjustment unit 212 is disposed between the mount frame 114 and the frame body 112. Thus, the mount frame 114 is not directly connected to the frame body 112. This is a difference from the mount frame114 as shown in FIG. 1 to FIG. 2.

The vertical level adjustment unit 212 adjusts the vertical level of the mount frame 114 with respect to the frame body 112 so as to match the vertical levels of the lower leg support 120 and the upper leg support 130 to the patient's lower and upper legs, respectively. For example, the vertical level adjustment unit 212 may include a vertical level adjustment groove 214 formed in the frame body 112, a vertical level adjustment bar 216 protruding in a bar shape from the mount frame 114 so as to be slidably inserted into the vertical level adjustment groove 214, and a fixing member 218 that fixes a length by which the vertical level adjustment bar 216 is inserted into the vertical level adjustment groove 214.

In this regard, the fixing member 218 may include a fastening member fastened to the vertical level adjustment groove 214 while passing therethrough. As the fastening member as described above is fastened to the vertical level adjustment groove 214, the fastener member approaches the vertical level adjustment bar 216 inserted into the vertical level adjustment groove 214, and then may be pressed onto a surface of the vertical level adjustment bar 216 or may be inserted into any one of a plurality of holes formed in the vertical level adjustment bar 216. Therefore, the vertical level adjustment bar 216 may be inserted to the vertical level adjustment groove 214 by a certain length and may be fixed thereto by the fixing member 218.

In one example, the wheelchair fixing unit 250 of the present embodiment is a component that fixes the wheels 14 and 16 of the wheelchair 10 when the wheelchair 10 has been displaced to the set position appropriate for rehabilitation exercise of the knee joint. The wheelchair fixing unit 250 may be provided on each of both opposing sides of a lower end of the rehabilitation apparatus frame 210. A location on the rehabilitation apparatus frame 210 at which the wheelchair fixing unit 250 is installed may be changed. In other words, when the position on the rehabilitation apparatus frame 210 where the wheelchair fixing unit 250 is installed is changed, the set position of the wheelchair 10 for rehabilitation exercise of the knee joint may be displaced, and accordingly, the set position of the wheelchair 10 may be appropriately adjusted depending on the patient's physical size or the leg length.

As shown in FIGS. 4 to 6, the wheelchair fixing unit 250 may include a wheel support plate 252 and a wheel fixing portion 254.

Since the wheel support plate 252 has the same structure as the wheel support plate 152 shown in FIGS. 1 to 3, detailed description thereof will be omitted.

However, in this embodiment, fixing portions for fixing the wheel support plate 252 are respectively provided at a plurality of positions along the lower end of the frame body 112. Thus, the wheel support plate 252 may be selectively fixed to any one of the plurality of fixing portions formed in the lower end of the frame body 112.

The wheel fixing portion 254 has a structure for fixing the auxiliary wheel 16 of the wheelchair 10 having got on a top of the wheel support plate 252, and may be formed integrally with the upper portion of the wheel support plate 252. For example, the wheel fixing portion 254 may include a wheel receiving groove 256 into which the lower portion of the auxiliary wheel 16 of the wheelchair 10 having got on the wheel support plate 252 is fixedly inserted, and a wheel stopper 258 for fixing the auxiliary wheel 16 inserted into the wheel receiving groove 256 within the inside of the wheel receiving groove 256.

In this regard, the wheel receiving groove 256 may have a straight groove defined in the top of the wheel support plate 252 and extending along the moving direction of the auxiliary wheel 16. Compared to the wheel receiving groove 156 as shown in FIGS. 1 to 3, the wheel receiving groove 256 of the present embodiment is constructed such that front and rear portions defining the wheel receiving groove 256 are open such that as the auxiliary wheel 16 moves along the wheel receiving groove 256, the auxiliary wheel 16 passes over the wheel support plate 252.

Additionally, the wheel stopper 258 may be provided on a bottom surface defining the wheel receiving groove 256 so as to stop the auxiliary wheel 16 of the wheelchair 10. Compared to the wheel stopper 158 as shown in FIGS. 1 to 3, the wheel stopper 258 of this embodiment is embodied as a stopping hole into which the lower portion of the auxiliary wheel 16 is inserted, wherein the hole is formed in a center of the bottom surface defining the wheel receiving groove 256. When the wheelchair 10 is moving, the lower portion of the auxiliary wheel 16 may be inserted into the stopping hole as described above, thereby stopping the movement of the auxiliary wheel 16. Therefore, the wheel stopper 258 of this embodiment has a simpler structure than that of the wheel stopper 158 shown in FIGS. 1 to 3 and may be easily manufactured.

As described above, the embodiments of the present disclosure have been described with reference to the specific details such as specific components and limited examples and drawings. This is only provided to help with a more general understanding of the present disclosure. The present disclosure is not limited to the above embodiments. Those with ordinary knowledge in the field to which the present disclosure belongs may make various modifications and variations from these descriptions. Therefore, the idea of the present disclosure should not be limited to the described embodiments, and not only the claims described later, equivalents to the scope of this claim may fall within the scope of the idea of the present disclosure.

What is claimed is:

1. A knee joint rehabilitation apparatus for a wheelchair, the apparatus comprising:
a rehabilitation apparatus frame having a height corresponding to a length of each of legs of a patient sitting on the wheelchair;
an upper leg support disposed at an upper end of the rehabilitation apparatus frame and supporting upper legs of the patient thereon while the patient is sitting on the wheelchair;
a lower leg support pivotably connected to the upper leg support, wherein the lower legs of the patient are seated and supported on the lower leg support; and
an exercise control unit disposed on the rehabilitation apparatus frame and configured to allow the lower leg support to pivot around a connection portion between the lower leg support and the upper leg support such that the patient performs rehabilitation exercise of the knee joint thereof while sitting on the wheelchair.

2. The apparatus of claim 1, wherein the apparatus further comprises a wheelchair fixing unit disposed on each of both opposing sides of a lower end of the rehabilitation apparatus frame and configured to fix the wheel of the wheelchair to prevent unintentional movement of the wheelchair when the wheelchair has been moved to a set position for the rehabilitation exercise of the knee joint.

3. The apparatus of claim 2, wherein the wheel of the wheelchair includes a main wheel provided on each of both opposing sides of the wheelchair; and an auxiliary wheel provided on each of both opposing sides of a front portion of the wheelchair to assist the movement of the main wheel,
wherein when the wheelchair has been positioned at the set position, the auxiliary wheel is stopped and fixed by the wheelchair fixing unit.

4. The apparatus of claim 2, wherein the wheelchair fixing unit includes:
a wheel support plate formed in a shape of a plate and mounted on the lower end of the frame body so that the wheel of the wheelchair gets on the wheel support plate as the wheelchair is moving to the set position; and
a wheel fixing portion formed on a top of the wheel support plate so as to fix the wheel of the wheelchair having got on the top of the wheel support plate.

5. The apparatus of claim 4, wherein the wheel fixing portion includes a wheel receiving groove defined in an upper portion of the wheel support plate and extending along a direction in which the wheel of the wheelchair moves so that a lower portion of the wheel of the wheelchair having got on the wheel support plate is inserted into the wheel receiving groove.

6. The apparatus of claim 5, wherein the wheel fixing portion further includes a wheel stopper disposed on a bottom surface defining the wheel receiving groove and having a structure constructed to stop the lower portion of the wheel of the wheelchair to fix the wheel of the wheelchair inserted into the wheel receiving groove,
wherein the wheel stopper is embodied as a stopping protrusion protruding from the bottom surface defining the wheel receiving groove at a wheel inlet position thereof, or a stopping hole formed in a center of the bottom surface defining the wheel receiving groove.

7. The apparatus of claim 2, wherein the wheelchair fixing unit is installed on each of both opposing sides of a lower end of the rehabilitation apparatus frame, wherein the wheelchair fixing unit is able to be displaced in an anteroposterior direction to adjust positions of the lower leg support and the upper leg support in the anteroposterior direction in a corresponding manner to positions in the anteroposterior direction of the legs of the patient sitting on the wheelchair.

8. The apparatus of claim 1, wherein a height of the rehabilitation apparatus frame is adjusted so as to adjust vertical levels of the lower leg support and the upper leg support in a corresponding manner to vertical levels of the legs of the patient sitting on the wheelchair.

9. The apparatus of claim 8, wherein the rehabilitation apparatus frame includes:
a frame body fixedly mounted on a ground;
a mount frame on which the lower leg support, the upper leg support, and the exercise control unit are installed; and
a vertical level adjustment unit connected to and disposed between the mount frame and the frame body and configured to adjust a vertical level of the mount frame.
